(19) United States
(12) Patent Application Publication
(10) Pub. No.: US 2007/0142041 A1
(43) Pub. Date: Jun. 21, 2007

(54) Configuring a mobile telephone

(75) Inventor: Karl J. Wood, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,069

(22) PCT Filed: Feb. 17, 2005
(86) PCT No.: PCT/IB05/50600

§ 371 Date: Aug. 17, 2006

(30) Foreign Application Priority Data
Feb. 24, 2004 (GB) 0403971.5

(51) Int. Cl. H04M 3/00

(52) U.S. Cl. 455/418

(57) ABSTRACT

A method for controlling the communication functionality of a mobile phone in which configuration data is provided (104) and received (108). Voice calls using the mobile phone are controlled (110) by impeding or limiting the ability to conduct such calls to encourage use of alternative communication such as SMS text messaging.

The present invention relates to mobile telephony and in particular to a method and system for controlling the communication functionality of a mobile telephone.

Usage of mobile phones is widespread. The effect of radio frequency radiation from mobile phones on human tissue, such as the brain, continues to be the subject of study and assessment without any conclusive results to date. Various proposals have been put forward to help mitigate exposure to such radiation. US Patent Application US2003/0083058 A1 suggests the level of microwave radiation to which the user is exposed is reduced by a large factor by enabling the phone to communicate with a very near proxy device by using low levels of radiation to communicate wirelessly with the proxy device. In one embodiment the cellphone requires a redesign, for example to use Bluetooth to communicate with the proxy. In another embodiment, the proxy imitates a cell (base station) of the cellphone network. Such an arrangement could be difficult to implement within an existing cellphone network since the proposed proxy (cell) would typically be mobile and, for example, handover is organised with respect to a mobile phone rather than a mobile cell.

A New Scientist article (http://www.newscientist.com/opinion/opfeedback.jsp;jsessionid=LOCEPODNNMCE?id=ns241299), viewed on Feb. 17, 2004, mentions a UK government report on cellphone radiation risks which advises a precautionary approach, especially for children. The article cites Medical Research Council advice suggesting that children listen instead of talk since, for example, the feature DTX (discontinuous transmission) saves battery power in digital cellphones by drastically cutting the power of the signal the phone transmits when the user stops talking. Such advice suggests there is a requirement for a convenient means to discourage talking on mobile phones, particularly by children.

It is an object of the present invention to improve on the known art.

In accordance with the present invention there is provided a method for controlling the communication functionality of a mobile phone comprising:
providing configuration data;
receiving configuration data; and
controlling the availability of the voice transmission functionality of the mobile phone according to the configuration data.

In contrast with prior art methods, the present invention provides control of the availability of the voice transmission functionality of a mobile phone, whilst maintaining the other functionalities of the phone. At one level, the user when attempting to make a voice call on the mobile phone is by a suitable means discouraged from doing so, for example by impeding access to that functionality. The process of impeding may comprise delaying access to the functionality and/or prompting the user to use an alternative transmission functionality, for example Short Message Service (SMS) text messaging. At another level, use of the voice transmission functionality of the mobile phone may be controlled in accordance with a pre-determined budget; for example limiting the time duration of voice calls using the mobile phone or the time duration of voice transmission from the mobile phone. Preferably, such durations are measured over a pre-determined time interval such as per hour, day or week. Advantageously, the above measures to control the making of a voice call can be implemented using hardware provided in currently deployed phones and/or networks plus the addition of suitable software. Alternatively, for certain implementations a combination of additional (and perhaps custom) hardware and/or software may be used.

When receiving voice calls, the above budget control method could be deployed. Alternatively, for example where a significant reduction in radiation emission is required, preferably incoming voice calls are routed to a voicemail facility. The mobile phone user may then pickup the voicemail in the conventional way while the radiation emitted by the phone is reduced for example by means of DTX control. Alternatively, a voicemail may be transcoded to an SMS text message which is then received and displayed on the phone. Response to incoming voice calls is preferably via SMS text message; compared to a regular voice call, this arrangement allows the transmitter to be held away from the user's head whilst transmitting, which the prior art suggests may be an advantage. A further advantage is a shorter aggregate transmission duration since interaction with the calling party using SMS is likely to result in sending just a few SMS messages each having a transmission time duration of only a few seconds. In the case where a calling party does not have SMS capability (for example, the parents' standard voice-only telephone) means can be provided to transcode SMS messages to/from voice messages.

According to the present invention there is also provided a system for controlling the communication functionality of a mobile phone comprising:
an interface arranged to enable a controller to input configuration data;
a data terminal operable to receive the configuration data from the interface and to communicate the configuration data to a network;
a network comprising a base station operable to receive the configuration data and to communicate with a mobile phone; and
a mobile phone operable to communicate with the base station and to control the availability of its voice transmission functionality according to the configuration data.

Advantageously, the system enables the configuration data to be received and utilised according to the capabilities of the network and the mobile phone. A controller, such as a parent or organisation entitled to control the communication functionality of a mobile phone, provides configuration data via an interface. This may be achieved by means of the user interface of the subject mobile phone, perhaps using a configuration mode which is preferably accessible under password or other restricted access control means to avoid being overridden by a phone user, such as the child of the parent. Alternatively, such data may comprise one or more verbal commands which are then transcoded into a corresponding data message comprising the configuration data, for example a parent verbally instructing a suitable service provider by telephone. A further alternative is to provide configuration data as a completed data form, for example a Web form on a Web browser, from which can be composed a corresponding data message comprising the configuration data. Preferably, the configuration data is received by the network serving the phone; advantageously, this allows control of the phone without physical access thereto. In addition, the specific capabilities of the respective network and phone can be optimally utilised to effect the desired control, for example use of the network to control the phone's voice transmission function, use of DTX functionality within the phone, use of voicemail and text messaging, or other capabilities available within the mobile phone and/or network.

The present invention recognises that by controlling the availability of voice transmission functionality of the mobile phone the radiation emitted from the mobile phone can be controlled. Advantageously, the invention discloses that such control can be exercised at a range of levels allowing flexibility on behalf of a person or organisation applying such control, for example a parent can apply a level of control he/she considers appropriate for his/her child. Furthermore, some level of control may be achieved using the capability of existing mobile phones and network infrastructure enabling a cost effective deployment by avoiding the need for any redesign and/or upgrading of the mobile phone and/or network, in particular the invention encourages the use of SMS text messaging in place of making of a voice call. Advantageously the invention further recognises that SMS text messaging is a useful alternative for responding to an incoming voice call, particularly in the case where receipt of such calls is restricted. The invention encourages manually invoked transmissions (such as SMS messaging) as an alternative to voice calls. This enables the transmitter to be used held away from the user's head at the time of transmission which the prior art suggests may be an advantage, coupled with a likely shorter aggregate transmission time than would occur with a voice call which also allows power saving benefits to extend battery life.

Embodiments of the present invention will now be described, by way of example only, with reference to the accompanying drawings in which:

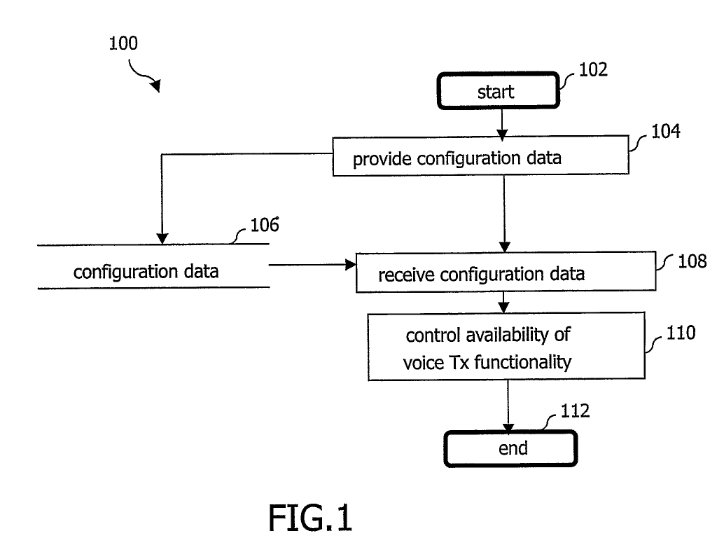

FIG. 1 shows a method for controlling the communication functionality of a mobile phone; and

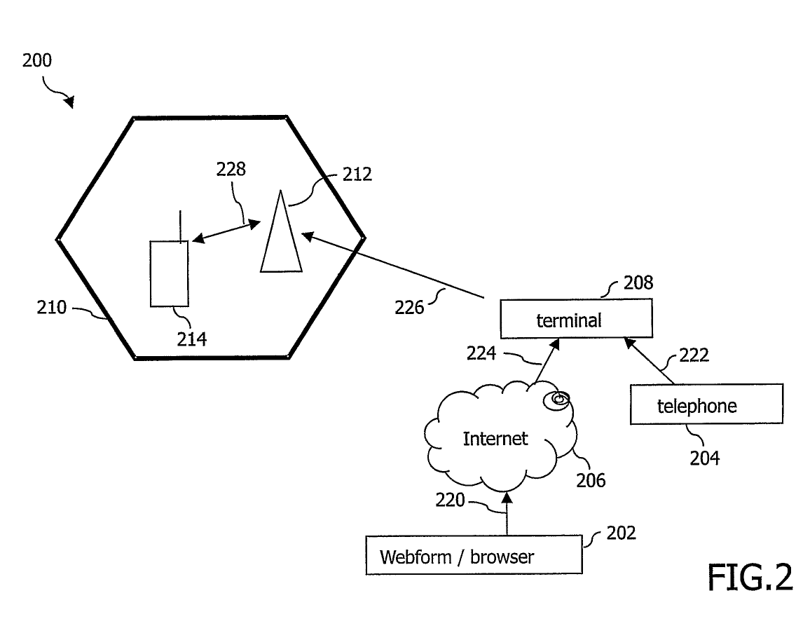

FIG. 2 shows a system for controlling the communication functionality of a mobile phone.

FIG. 1 shows a method for controlling the communication functionality of a mobile phone. The method, shown generally at 100, starts at 102 and configuration data is provided at 104. Configuration data may be provided by means of inputs entered via the user interface of the mobile phone. For example, a menu within the user interface of the mobile phone allows configuration settings to be changed. Preferably, access to the menu is restricted (for example, using a password) to prevent unauthorised alteration of the settings. Such settings are used to derive corresponding configuration data 106 which in this case is received 108 at the mobile phone. In a preferred example, configuration data is provided by means of inputs entered via a user interface which is separate and independent to the mobile phone. One example is verbal commands issued, for example from a standard voice-only telephone, to a human operator, who then arranges the transcoding of the verbal commands into corresponding configuration data 106 which is then in turn received 108 at the network serving the mobile phone. As an alternative, selected configuration settings may be input in machine readable format, for example using a menu based user interface as discussed above, or a Web form running on a Web browser, from which (or other similar formats) suitable data can be extracted and used to compose corresponding configuration data 106 which is then in turn received 108 at the network serving the mobile phone.

The method then controls 110 the availability of the voice transmission functionality of the mobile phone according to the configuration data. Control may be effected locally and/or remotely with respect to the mobile phone, the choice perhaps being dependent on the capability of the phone and network. Control can comprise impeding access to voice transmission functionality. In one example, in response to the user wishing to make a voice call, the user may be prompted by means of an audible and/or displayed message suggesting the use of an alternative transmission functionality in place of the voice call, such as SMS text messaging. Preferably, such a prompt would be used in conjunction with a delay inhibiting availability to place voice calls for a pre-determined time period, for example 60 seconds. Alternatively, such a delay may be invoked without any associated prompt. Preferably an SMS message is sent by manual actuation of the phone user interface (for example keypad) to encourage the mobile phone transmitter to be positioned away from the users head when transmission is executed. In another example, control impedes access by preventing the placing (making) of a voice call by the mobile phone user while preferably still permitting pre-determined types of call (for example, emergency SOS) to be made. Advantageously, some users, particularly children, are both familiar and comfortable using SMS text messaging.

An alternative control of the availability of the voice transmission functionality is to budget its usage. As an example, the time duration of voice calls using the mobile phone is budgeted, such as the aggregate duration of such calls, preferably measured over a pre-determined time interval such as per hour, day, etc. In this way the radiation emitted due to voice transmission can be regulated to an approximate degree. In a preferred example, the duration of voice transmission from the mobile phone is budgeted, such as the aggregate duration thereof, again preferably measured over a pre-determined time interval such as per hour, day, etc. Clearly, the budget can be set from zero to any suitable value, as deemed appropriate. The method ends at 112.

FIG. 2 shows a system, shown generally at 200, for controlling the communication functionality of a mobile phone. The system comprises an interface arranged to enable a user to input configuration data. In one example, the interface is a standard voice telephone 204, the configuration data comprising one or more verbal (spoken) commands 222 which are then interpreted (for example by a human operator, or voice recognition) into machine readable configuration data at data terminal 208. In another example, the interface enables the user to input configuration data as machine readable data such as keypad inputs, menu selections or the like; preferably the interface comprises a Web form running on a Web browser 202. The completed Web form 220 is forwarded via a network such as the Internet 206 which then forwards the form 224 to data terminal 208. The data terminal may be a server on the Internet, a mobile phone network entity (for example the customer management system of the mobile phone network) or the like. Optionally, the data terminal may perform authentication to ensure only authorised persons or organisations can change the configuration data; suitable methods for such authentication are known to the skilled person. The data terminal 208 communicates the configuration data 226 to a basestation 212 (presently serving the mobile phone 214) of mobile phone network 210 using the existing data routing means of the network (for clarity, not shown in FIG. 2). In turn, the basestation communicates 228 with the mobile phone thereby controlling the availability of the voice transmission functionality of the mobile phone according to the configuration data 226. Communication links in the system may be wired and/or wireless as appropriate.

Examples of controlling the availability of the voice transmission functionality of the mobile phone are described below. These are not exhaustive and alternatives are readily identifiable by the skilled person. Depending on the desired configuration, when the user wishes to place a voice call the mobile phone responds with a (annunciated/displayed) prompt and/or delay to discourage placing the call; alternatively, where a suitable pre-determined budget is not exhausted, it may allow the call; alternatively, it may prevent the call and advise the user to employ an alternative transmission functionality such as SMS text messaging, paging or the like. In the case of an incoming call, where a suitable pre-determined budget is not exhausted, it may allow the user to answer the call in the normal way. In case the pre-determined budget is exhausted, the mobile phone may inform 228 the mobile phone network 210 to prevent further incoming calls, these can then be routed to a voicemail or answering service facility; the user can then access (listen) to such calls on a receive-only basis (that is, with the voice transmission functionality disabled at the mobile phone using DTX, an electronic switch or other suitable means). Optionally the voicemail might be converted to an SMS text message and sent to the mobile phone. In either case, the user can then respond also using SMS text messaging. Preferably, the phone or network is equipped with transcoding means to serve called/calling parties which cannot send and/or render SMS text messages (for example users of standard voice-only telephones); such means may comprise human transcription or synthesised methods. In the latter case, system performance and cost benefits accrue from the use of a standardised word and phrase vocabulary.

The foregoing method and implementation are presented by way of examples only and represent a selection of a range of methods and implementations that can readily be identified by a person skilled in the art to exploit the advantages of the present invention.

In the description above and with reference to FIG. 1, there is provided a method for controlling the communication functionality of a mobile phone in which configuration data is provided 104 and received 108. Voice calls using the mobile phone are controlled 110 by impeding or limiting the ability to conduct such calls to encourage use of alternative communication such as SMS text messaging.

1. A method for controlling the communication functionality of a mobile phone comprising:
providing (104) configuration data;
receiving (108) configuration data; and
controlling (110) of voice transmission functionality of the mobile phone according to the configuration data.

2. A method as claimed in claim 1, wherein the configuration data is received via the user interface of the mobile phone.

3. A method as claimed in claim 1, wherein the configuration data is received via a network serving the mobile phone.

4. A method as claimed in claim 1, wherein the availability of the voice transmission functionality is controlled by impeding access to said functionality.

5. A method as claimed in claim 4, wherein impeding comprises prompting the use of an alternative transmission functionality.

6. A method as claimed in claim 4, wherein impeding comprises delaying access to the voice transmission functionality.

7. A method as claimed in claim 1, wherein the availability of the voice transmission functionality is controlled in accordance with a pre-determined budget.

8. A method as claimed in claim 7, wherein the budget is the time duration of voice calls using the mobile phone.

9. A method as claimed in claim 7, wherein the budget is based on the time duration of voice transmission from the mobile phone.

10. A method as claimed in claim 8, wherein the time duration is measured over a pre-determined time interval.

11. A system for controlling the communication functionality of a mobile phone comprising:
an interface (202, 204) arranged to enable a controller to input configuration data;
a data terminal (208) operable to receive the configuration data from the interface and to communicate the configuration data to a network;
a network (210) comprising a base station (212) operable to receive the configuration data and to communicate with a mobile phone; and
a mobile phone (214) operable to communicate with the base station and to control the availability of its voice transmission functionality according to the configuration data.

12. A system as claimed in claim 11, wherein the interface is a Web form running on a Web browser, the input configuration data comprises data within the Web form, and the data terminal is further operable to extract the data within the Web form and to compose a data message comprising corresponding configuration data for the network.

13. A system as claimed in claim 11, wherein the interface is a telephone (204), the input configuration data comprises a verbal command, and the data terminal is further operable to transcode the verbal command to a data message comprising corresponding configuration data for the network.

14. A mobile phone comprising:
a user interface arranged to enable a controller to input configuration data; and
a processor operable to receive the configuration data from the user interface and to control availability of voice transmission functionality of the mobile phone according to the configuration data.

15. A record carrier comprising software operable to carry out the method of claim 1.

16. A software utility configured for carrying out the method steps as claimed in claim 1.

17. A mobile phone for use in a system as claimed in claim 11 and operating under control of a software utility configured for carrying out the steps of:
providing (104) configuration data;
receiving (108) configuration data; and
controlling (110) availability of voice transmission functionality of the mobile phone according to the configuration data.
